(19) United States
(12) Patent Application Publication
(10) Pub. No.: US 2016/0343298 A1
(43) Pub. Date: Nov. 24, 2016

(54) PIXEL DRIVING CIRCUIT OF ORGANIC LIGHT EMITTING DISPLAY

(71) Applicant: SHENZHEN CHINA STAR OPTOELECTRONICS TECHNOLOGY CO., LTD., Shenzhen, Guangdong (CN)

(72) Inventor: Xiangyang XU, Shenzhen, Guangdong (CN)

(73) Assignee: Shenzhen China Star Optoelectronics Technology Co., Ltd., Shenzhen, Guangdong (CN)

(21) Appl. No.: 14/423,672

(22) PCT Filed: Dec. 1, 2014
(86) PCT No.: PCT/CN2014/092656

§ 371 Date: Feb. 24, 2015

(30) Foreign Application Priority Data
Nov. 4, 2014 (CN) 201410614776.2

(51) Int. Cl. G09G 3/3233

(52) U.S. Cl. CPC G09G 3/3233; G09G 2300/0819; G09G 2320/045; G09G 2300/0465

(57) ABSTRACT

An OLED pixel driving circuit includes a first transistor controlled by a scan driving signal to control transmission of a data signal and a reference voltage signal to a first electrode plate of a capacitor; a second transistor electrically connected to a second electrode plate of the capacitor to determine magnitude of a driving current, where the driving current is determined by a voltage difference between a gate and a drain of the second transistor; a third transistor electrically connected to the second electrode plate of the capacitor and the second transistor and controlled by a first driving signal to control conduction or cut-off between the gate and the drain of the second transistor; and a fourth transistor electrically connected to the second transistor and the third transistor and controlled by a second driving signal to control transmission of the driving current to an organic light emitting element.

### CROSS REFERENCE TO RELATED APPLICATIONS

This application claims the priority of Chinese Patent Application No. 201410614776.2, entitled “Pixel Driving Circuit of Organic Light Emitting Display”, filed on Nov. 4, 2014, the disclosure of which is incorporated herein by reference in its entirety.

### BACKGROUND OF THE INVENTION

1. Field of the Invention

The present invention relates to the field of organic light emission displaying, and in particular to a pixel driving circuit of an organic light emitting display.

2. The Related Arts

An organic light emitting display (OLED) is a thin-film light-emitting device that is made of an organic semiconductor material and is driven by using a direct-current (DC) voltage and that has a self-luminous characteristic. The OLED is generally composed of a relatively thin organic material coating layer and a glass substrate without the inclusion of a backlighting source. Thus, when an electrical current is conducted on, the organic material actively emits light.

Since the OLED is driven by an electric current, the brightness of light emission of the OLED is related to the electric current flowing through the OLED. Thus, the electrical property of a driving thin-film transistor (TFT) may directly affect the performance of displaying of the OLED. Particularly, the threshold value of the TFT often drifts, leading to a problem of non-uniform brightness of the entire OLED displaying device.

To improve the displaying performance of the OLED, it often uses a driving circuit to achieve compensation for pixels of the OLED. However, in the conventional OLED pixel compensation circuit, a data voltage signal and a reference voltage signal must be supplied through different wiring and the data voltage signal and the reference voltage signal each require a TFT for timing control output. Thus, the conventional OLED pixel compensation circuit needs more components (such as transistors). This increases the wiring cost and also increases complexity of wiring.

### SUMMARY OF THE INVENTION

The present invention provides a pixel driving circuit of an organic light emitting display that uses less components so as to not only lower down wiring cost of the entire circuit but also provides a simple circuit structure for reducing wiring and helping increase aperture ratio of a panel.

In an aspect, the present invention provides a pixel driving circuit of an organic light emitting display (OLED). The OLED pixel driving circuit comprises: a first transistor, a second transistor, a third transistor, a fourth transistor, and a capacitor;
the first transistor being controlled by a scan driving signal for controlling transmission of a data signal and a reference voltage signal a first electrode plate of the capacitor;
the second transistor being electrically connected to the second electrode plate of the capacitor for determining a magnitude of a driving current, where the driving current is determined by a voltage difference between a gate and a drain of the second transistor;
the third transistor being electrically connected to the second electrode plate of the capacitor and the second transistor and being controlled by a first driving signal for controlling conduction and cut-off between the gate and the drain of the second transistor; and
the fourth transistor being electrically connected to the second transistor and the third transistor and being controlled by a second driving signal for controlling transmission of the driving current from the second transistor to an organic light emitting element.

In the above OLED pixel driving circuit, the first transistor is a scan transistor, which has a first electrode, serving as a signal input terminal, electrically connected to a signal line and receiving inputs of the data signal and the reference voltage signal, the first transistor having a second electrode electrically connected to the first electrode plate of the capacitor, the first transistor having a gate controlled by the scan driving signal for controlling the transmission of the data signal and the reference voltage signal to the first electrode plate of the capacitor.

In the above OLED pixel driving circuit, the second transistor is a driving transistor, which has a first electrode electrically connected to a the power supply voltage signal line to receive an input of a power supply voltage signal, the second transistor having a second electrode electrically connected to a second electrode of the third transistor and a first electrode of the fourth transistor, the second transistor having a gate electrically connected to the second electrode plate of the capacitor and a first electrode of the third transistor.

In the above OLED pixel driving circuit, the third transistor is a compensation circuit transistor, which has a first electrode electrically connected to a gate of the second transistor and the second electrode plate of the capacitor, the third transistor having a second electrode electrically connected to a second electrode of the second transistor and a first electrode of the fourth transistor.

In the above OLED pixel driving circuit, the fourth transistor is node restoration control transistor, which has a first electrode electrically connected to a second electrode of the second transistor and a second electrode of the third transistor, the fourth transistor having a second electrode electrically connected to the organic light emitting element, the organic light emitting element being operable to light and display in response to the driving current.

In the above OLED pixel driving circuit, the first transistor, the second transistor, the third transistor, and the fourth transistor are all P-type transistors; or
the first transistor, the second transistor, the third transistor, and the fourth transistor are all N-type transistors; or
the first transistor, the third transistor, and the fourth transistor are N-type transistors and the second transistor is a P-type transistor.

In the above OLED pixel driving circuit, the pixel driving circuit involves a driving sequence that comprises: a node voltage restoration phase, a threshold voltage detection phase, a reference voltage signal writing phase, a voltage regulation balance phase, and a light emission phase, where in the node voltage restoration phase, the scan driving signal applied to a gate of the first transistor is a low voltage level and the first driving signal is a low voltage level so that the first transistor, the third transistor, and the fourth transistor conduct on, and the second driving signal is a low voltage level so that the second transistor is in a cut-off state.

In the above OLED pixel driving circuit, in the threshold voltage detection phase, the scan driving signal applied to the gate of the first transistor is a low voltage level and the first driving signal is a low voltage level so that the first transistor and the third transistor conduct on; the second driving signal is a high voltage level so that the second transistor and the fourth transistor is in a cut-off state; and in the threshold voltage detection phase, a voltage difference between the first electrode plate and the second electrode plate of the capacitor involve a threshold voltage of the second transistor and the threshold voltage is stored in the capacitor.

In the above OLED pixel driving circuit, in the reference voltage signal writing phase, the scan driving signal applied to the gate of the first transistor is a low voltage level and the first driving signal is a high voltage level so that the third transistor is in a cut-off state and the first transistor conducts; and the second driving signal is a high voltage level so that the second transistor and the fourth transistor are in a cut-off state; and the data signal is coupled, via the capacitor, to the second electrode plate of the capacitor.

In the above OLED pixel driving circuit, in voltage regulation balance phase, the scan driving signal applied to the gate of the first transistor is a high voltage level so that the first transistor is in a cut-off state and the first electrode plate of the capacitor is open; the first driving signal is a high voltage level so that the third transistor is in a cut-off state; and the second driving signal is a high voltage level so that the second transistor and the fourth transistor are in a cut-off state; and
in the light emission phase, the scan driving signal applied to the gate of the first transistor is a high voltage level so that the first transistor is in a cut-off state; the first driving signal is a high voltage level so that the third transistor is in a cut-off state; the second driving signal is a low voltage level so that the second transistor and the fourth transistor conduct on; and the driving current is transmitted through the fourth transistor to the organic light emitting element to drive the organic light emitting element to light and display.

In another aspect, the present invention provides a driving method of an organic light emitting device (OLED), wherein the OLED driving method uses a pixel driving circuit to carry out driving of a pixel, the pixel driving circuit comprising: a first transistor, a second transistor, a third transistor, a fourth transistor, and a capacitor; the first transistor, the second transistor, the third transistor, and the fourth transistor being all P-type transistors; the driving method comprising the following steps: node voltage restoration, threshold voltage detection, reference voltage signal writing, voltage regulation balance, and light emission.

In the above driving method, in the node voltage restoration step, a scan driving signal applied to a gate of the first transistor is a low voltage level and a first driving signal is a low voltage level so that the first transistor, the third transistor, and the fourth transistor conduct on; and a second driving signal is a low voltage level so that the second transistor is in a cut-off state; a data signal being transmitted through the first transistor to a first electrode plate of a capacitor.

In the above driving method, in the threshold voltage detection step, the scan driving signal applied to the gate of the first transistor is a low voltage level and the first driving signal is a low voltage level so that the first transistor and the third transistor conduct on; the second driving signal is a high voltage level so that the second transistor and the fourth transistor are in a cut-off state; and when a gate voltage of the second transistor is pulled up to an extent that a voltage difference thereof from a source voltage is less than or equal to a threshold voltage of the second transistor, the second transistor is set in a cut-off state and the threshold voltage is stored in the capacitor.

In the above driving method, in the reference voltage signal writing step, the scan driving signal applied to the gate of the first transistor is a low voltage level and the first driving signal is a high voltage level so that the third transistor is in a cut-off state and the first transistor conducts on; the second driving signal is a high voltage level so that the second transistor and the fourth transistor are in a cut-off state; and a reference voltage signal is transmitted through the first transistor to the first electrode plate of the capacitor, the second transistor, the third transistor, and the fourth transistor being all in a cut-off state, a data signal being coupled, via the capacitor, to the second electrode plate of the capacitor.

In the above driving method, in the voltage regulation balance step, the scan driving signal applied to the gate of the first transistor is a high voltage level so that the first transistor is in a cut-off state, and the first driving signal is a high voltage level so that the third transistor is in a cut-off state; the second driving signal is a high voltage level so that the second transistor and the fourth transistor are in cut-off state; and
in the light emission phase, the scan driving signal applied to the gate of the first transistor is a high voltage level so that the first transistor is in a cut-off state; the first driving signal is a high voltage level so that the third transistor is in a cut-off state; the second driving signal is a low voltage level so that the second transistor and the fourth transistor conduct on, a driving current flowing through the fourth transistor and transmitted to the organic light emitting element to drive the organic light emitting element to light and display.

In the above driving method, the first transistor is a scan transistor; the second transistor is a driving transistor; the third transistor is a compensation circuit transistor; the fourth transistor is a node restoration control transistor; and the capacitor is a storage capacitor.

In a further aspect, the present invention provides an organic light emitting display (OLED), which comprises an organic light emitting element, wherein the OLED further comprises a pixel driving circuit, the OLED pixel driving circuit comprising: a first transistor, a second transistor, a third transistor, a fourth transistor, and a capacitor; the first transistor being controlled by a scan driving signal for controlling transmission of a data signal and a reference voltage signal a first electrode plate of the capacitor; the second transistor being electrically connected to the second electrode plate of the capacitor for determining a magnitude of a driving current, where the driving current is determined by a voltage difference between a gate and a drain of the second transistor; the third transistor being electrically connected to the second electrode plate of the capacitor and the second transistor and being controlled by a first driving signal for controlling conduction and cut-off between the gate and the drain of the second transistor; and the fourth transistor being electrically connected to the second transistor and the third transistor and being controlled by a second driving signal for controlling transmission of the driving current from the second transistor to an organic light emitting element, the organic light emitting element being operable to emit light in response to the driving current.

Compared to the prior art techniques, the present invention provides a pixel driving method of an organic light emitting display. A data voltage signal and the reference voltage signal are input through the same wiring line to a transistor and only one thin-film transistor for driving is needed to carry out timing control output of the data voltage signal and the reference voltage signal. As such, the use of circuit component (such as transistors) is reduced, the circuit structure is simplified, the wiring cost of the entire circuit is lowered down, and aperture ratio of a panel is increased through the reduction of the wiring.

### BRIEF DESCRIPTION OF THE DRAWINGS

To more clearly explain the technical solutions proposed in embodiments of the present invention or those of the prior art, a brief description of the drawings that are necessary for describing the embodiments of the present invention or those of the prior art is given as follows. It is obvious that the drawings that will be described below show only some embodiments of the present invention. For those having ordinary skills of the art, other drawings may also be readily available from these attached drawings without the expense of creative effort and endeavor.

FIG. 1 is a schematic view showing a pixel driving circuit of an organic light emitting display (OLED) according to an embodiment of the present invention;

FIG. 2 is a timing diagram of driving signals of the organic OLED pixel driving circuit according to an embodiment of the present invention;

FIG. 3 is a schematic view illustrating an electric current path in a node voltage restoration phase t1 of the organic OLED pixel driving circuit according to an embodiment of the present invention;

FIG. 4 is a schematic view illustrating an electric current path in a threshold voltage detection phase t2 of the organic OLED pixel driving circuit according to an embodiment of the present invention;

FIG. 5 is a schematic view illustrating an electric current path in a reference voltage signal writing phase t3 of the organic OLED pixel driving circuit according to an embodiment of the present invention;

FIG. 6 is a schematic view illustrating an electric current path in a light emission phase t5 of the organic OLED pixel driving circuit according to an embodiment of the present invention; and

FIG. 7 is a flow chart illustrating a method for driving an OLED pixel according to another embodiment of the present invention.

### DETAILED DESCRIPTION OF THE PREFERRED EMBODIMENTS

A clear and complete description will be given to technical solutions of the embodiments of the present invention with reference to the attached drawings of the embodiments of the present invention. However, the embodiments so described are only some, but not all, of the embodiments of the present invention. Other embodiments that are available to those having ordinary skills of the art without the expense of creative effort and endeavor are considered belonging to the scope of protection of the present invention.

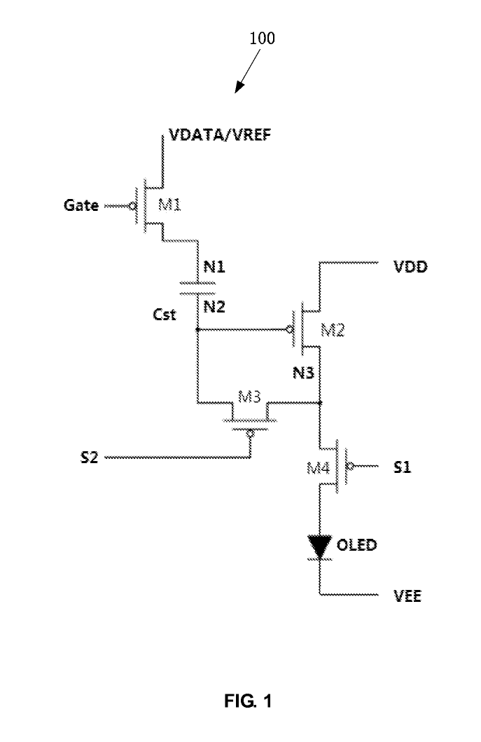

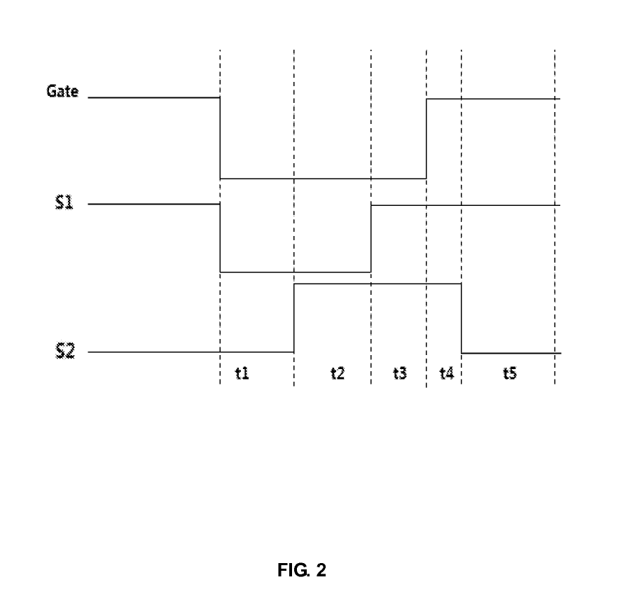

Referring to FIG. 1, FIG. 1 is a schematic view showing a pixel driving circuit of an organic light emitting display (OLED) according to an embodiment of the present invention. As shown in FIG. 2, the OLED pixel driving circuit 100 according to the embodiment of the present invention comprises at least: a first transistor M1, a second transistor M2, a third transistor M3, a fourth transistor M4, a capacitor Cst, and an organic light emitting element (organic light-emitting display) OLED. In the embodiment of the present invention, the pixel driving circuit 100 can be an AMOLED (active matrix/organic light emitting diode) driving circuit. The capacitor Cst can be a storage capacitor.

In the embodiment of the present invention, the first transistor M1 can be a scan transistor, which has a first electrode, serving as a signal input terminal, electrically connected to a signal line and receiving input data signal VDATA and reference voltage signal VREF; the first transistor M1 has a second electrode electrically connected to a first electrode plate of the capacitor Cst; and the first transistor M1 has a gate that is controlled by a scan driving signal to specifically control transmission of the data signal VDATA and the reference voltage signal VREF to the first electrode plate of the capacitor Cst. In the embodiment of the present invention, the first electrode of the first transistor M1 is a source and the second electrode is a drain.

In the embodiment of the present invention, the second transistor M2 can be a driving transistor, which has a first electrode, serving as a signal input terminal, is electrically connected to a power supply voltage signal line and receives an input power supply voltage signal VDD; the second transistor M2 has a second electrode electrically connected to a second electrode of the third transistor M3 and a first electrode of the fourth transistor M4; and the second transistor M2 has a gate electrically connected to a second electrode plate of the capacitor Cst and a first electrode of the third transistor M3. The second transistor M2 functions to determine the magnitude of a driving current, where the driving current is determined by a voltage difference between a gate and the first electrode of the second transistor M2. In the embodiment of the present invention, the first electrode of the second transistor M2 is a source and the second electrode is a drain.

In the embodiment of the present invention, the third transistor M3 can be a compensation circuit transistor, of which the first electrode is electrically connected to the gate of the second transistor M2 and the second electrode plate of the capacitor Cst; and the second electrode of the third transistor M3 is electrically connected to the second electrode of the second transistor M2 and the first electrode of the fourth transistor M4. The third transistor M3 has a gate that is controlled by a first driving signal S1 to specifically control conduction or cut-off between the gate and a drain (which is the second electrode) of the second transistor M2. In the embodiment of the present invention, the first electrode of the third transistor M3 is a source and the second electrode is a drain.

In the embodiment of the present invention, the fourth transistor M4 can be a node restoration control transistor, of which the first electrode is electrically connected to the second electrode of the second transistor M2 and the second electrode of the third transistor M3; and a second electrode of the fourth transistor M4 is electrically connected to the organic light emitting element OLED. The fourth transistor M4 has a gate that is controlled by a second driving signal S2 to specifically control transmission of the driving current from the second electrode of the second transistor M2 to the organic light emitting element OLED so that the organic light emitting element OLED may respond to the driving current to light and display. In the embodiment of the present invention, the first electrode of the fourth transistor M4 is a source and the second electrode is a drain.

Referring to FIG. 2, FIG. 2 is a timing diagram of driving signals of the organic OLED pixel driving circuit according to an embodiment of the present invention. The timing diagram of driving signals shown in FIG. 2 is only an example, which corresponds to a condition where the first transistor M1, the second transistor M2, the third transistor M3, and the fourth transistor M4 are all P-type transistors, such as P-channel metal-oxide semiconductor field effect transistor (MOS-FET). It can be appreciated that the first transistor M1, the second transistor M2, the third transistor M3, and the fourth transistor M4 can alternatively be transistors of other types (such as N-type transistors, specifically N-channel MOS-FET) and parameters, such as circuit connection, signal input, and transmission directions and magnitudes of signals, can be determined according to the requirements of practical circuit layout. Repeated description will be omitted here.

Referring to FIG. 2, specifically, the first driving signal S1 controls the third transistor M3 so as to control conduction or cut-off between the gate and the drain of the second transistor M2. The second driving signal S2 controls the fourth transistor M4 in order to transmit the driving current from the second transistor M2 to the organic light emitting element OLED. VDATA represents the data signal and VREF represents the reference voltage signal. The first driving signal S1 and the second driving signal S2 are both supplied from a gate driving line of the organic light emitting display.

As shown in FIG. 2, the driving sequence of the pixel driving circuit according to an embodiment of the present invention comprises: a node voltage restoration phase, a threshold voltage detection phase, a reference voltage signal VREF writing phase, a voltage regulation balance phase, and a light emission phase. These five phases respectively correspond to the time periods t1, t2, t3, t4, and t5 of FIG. 2. In the node voltage restoration phase t1, the first transistor M1, the third transistor M3, and the fourth transistor M4 are in a conducting-on state and this is a node voltage restoration phase of [symbol] the second node N2 of the capacitor Cst (namely the second electrode plate of the capacitor Cst); in the threshold voltage detection phase t2, the first transistor M1 and the third transistor M3 are in a conducting-on state and the second transistor M2 and the fourth transistor M4 are in a cut-off state, the first node N1 of the capacitor Cst (namely, the first electrode plate of the capacitor Cst) and the second node N2 are respectively of voltages of VDD-Vth and VDATA; in the reference voltage signal VREF writing phase t3, the first transistor M1 is in a conducting-on state and the second transistor M2, the third transistor M2, and the fourth transistor M4 are in cut-off state; and in the light emission phase t5, the first transistor M1 and the third transistor M3 are in a cut-off state and the second transistor M2 and the fourth transistor M4 are in a conducting-on state.

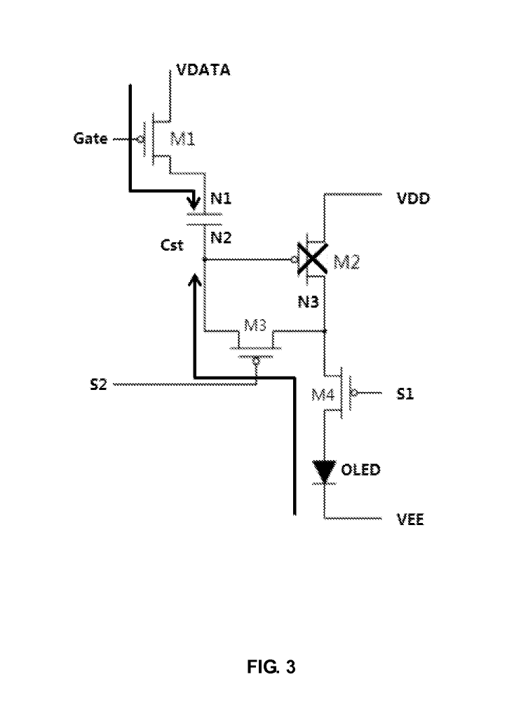

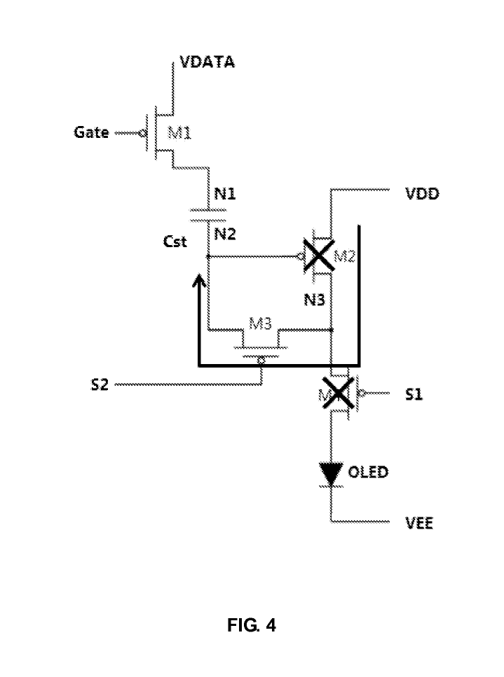

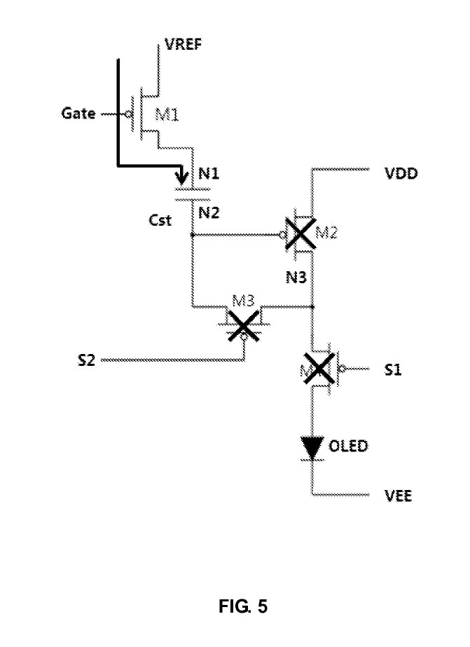

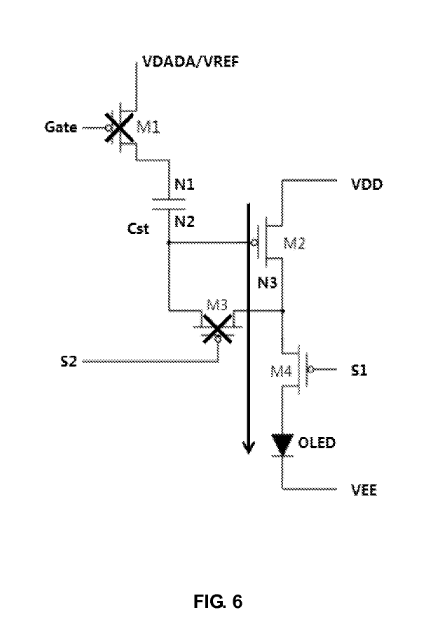

FIG. 3 is a schematic view illustrating an electric current path in the node voltage restoration phase t1 of the organic OLED pixel driving circuit according to an embodiment of the present invention; FIG. 4 is a schematic view illustrating an electric current path in the threshold voltage detection phase t2 of the organic OLED pixel driving circuit according to an embodiment of the present invention; and FIG. 5 is a schematic view illustrating an electric current path in the reference voltage signal writing phase t3 of the organic OLED pixel driving circuit according to an embodiment of the present invention. FIG. 6 is a schematic view illustrating an electric current path in the light emission phase t5 of the organic OLED pixel driving circuit according to an embodiment of the present invention. For easy explanation, in FIGS. 3-6, arrows are used to indicate the electrical current paths in various phases and symbols “X” that are placed on transistors are used to indicate the transistors are in a cut-off state.

The principle of operation of the OLED pixel driving circuit 100 according to an embodiment of the present invention will be described with reference to FIGS. 1-6.

As shown in FIGS. 2 and 3, in the node voltage restoration phase t1, the scan driving signal applied to the gate of the first transistor M1 is a low voltage level and the first driving signal S1 is a low voltage level so that the first transistor M1, the third transistor M3, and the fourth transistor M4 conduct on; and the second driving signal S2 is a low voltage level so that the second transistor M2 is in a cut-off state. It can be seen from FIG. 3 that the data signal VDATA is transmitted through the first transistor M1 to the first node N1 of the capacitor Cst, and at the same time, an electric current path is established between the third transistor M3 and the fourth transistor M4 so that the low voltage level VEE of a cathode of the organic light emitting element OLED is applied through the electric current path to the second node N2 of the capacitor Cst, whereby the gate of the second transistor M2 is also a low voltage level, and as such, the node voltage restoration process of the entire the pixel driving circuit 100 is completed.

As shown in FIGS. 2 and 4, in the threshold voltage detection phase t2, the scan driving signal applied to the gate of the first transistor M1 is a low voltage level and the first driving signal S1 is a low voltage level, so that the first transistor M1 and the third transistor M3 conduct on; and the second driving signal S2 is a high voltage level so that the second transistor M2 and the fourth transistor M4 are in a cut-off state. It can be seen from FIG. 4 that since in the node voltage restoration phase t1, the gate of the second transistor M2 is in a low voltage level, the second transistor M2 is in a conducting-on state, so that an electric current path is established between the second transistor M2 and the third transistor M3 and the power supply voltage signal VDD is transmitted through the electric current path to the second node N2 and thus, the potential of the second node N2 is raised by the power supply voltage signal VDD. According to the voltage-current characteristic of a transistor, when a voltage difference between the gate voltage and the source voltage of the transistor is smaller than the threshold voltage of the transistor, the transistor is cut off. In other words, when the voltage of the gate of the second transistor M2 is pulled up to such an extent that a voltage difference thereof from the source voltage is less than or equal to the threshold voltage Vth of the second transistor M2, the second transistor M2 is set in a cut-off state. Further, since the source of the second transistor M2 is electrically connected to the power supply voltage signal line, the source voltage is kept fixed at VDD, so that when the second transistor M2 is cut off, the voltage of the gate of the second transistor M2 is (VDD−Vth), where VDD is the power supply voltage and Vth is the threshold voltage of the second transistor M2. Under this condition, the voltage difference between the first electrode plate and the second electrode plate of the capacitor Cst is Vc:

Vc=V2−V1=VDD−Vth−VTATA (1)

where V2 represents the potential of the second node N2 of the capacitor Cst and V1 represents the potential of the first node N1 of the capacitor Cst. It can be seen from the above that in the threshold value detection phase t2, the voltage difference Vc between the first electrode plate and the second electrode plate of the capacitor Cst involves the threshold voltage Vth of the second transistor M2 and the threshold voltage Vth is stored in the capacitor Cst.

As shown in FIGS. 2 and 5, in the reference voltage signal VREF writing phase t3, the scan driving signal applied to the gate of the first transistor M1 is a low voltage level and the first driving signal S1 is a high voltage level, so that the third transistor M3 is in a cut-off state and the first transistor M1 conducts on; and the second driving signal S2 is a high voltage level so that the second transistor M2 and the fourth transistor M4 are in a cut-off state. It can be seen from FIG. 5 that the reference voltage signal VREF is transmitted through the first transistor M1 to the first node N1 of the capacitor Cst (namely the first electrode plate of the capacitor Cst) and at the same time, the second transistor M2, the third transistor M3, and the fourth transistor M4 are in a cut-off state, meaning the second electrode plate of the capacitor Cst is open so that the voltage difference Vc between the first electrode plate and the second electrode plate of the capacitor Cst is kept unchanged. However, since the potential of the first node N1 is changed to VREF, the potential V2′ of the second node N2 is correspondingly changed:

V2′=Vc+VREF=VDD−Vth−VDATA+VREF (2)

It can be seen from the above that the data signal VDATA is coupled, via the capacitor Cst, to the second electrode plate of the capacitor Cst.

In the voltage regulation balance phase t4, the scan driving signal applied to the gate of the first transistor M1 is a high voltage level and the first transistor M1 is in a cut-off state, meaning the first electrode plate of the capacitor Cst is opened; the first driving signal S1 is a high voltage level so that the third transistor M3 is in cut-off state; and the second driving signal S2 is a high voltage level, so that the second transistor M2 and the fourth transistor M4 are in a cut-off state. Thus, the potential of the second node N2 of the capacitor Cst is kept unchanged and so completing a voltage regulation balance process.

As shown in FIGS. 2 and 6, in the light emission phase t5, the scan driving signal applied to the gate of the first transistor M1 is a high voltage level, so that the first transistor M1 is in acut-off state; the first driving signal S1 is a high voltage level, so that the third transistor M3 is in a cut-off state; and the second driving signal S2 is a low voltage level, so that the second transistor M2 and the fourth transistor M4 conduct on. It can be seen from FIG. 6 that an electric current path is established between the second transistor M2 and the fourth transistor M4 and under this condition, the voltage difference Vgs between the gate and the source of the second transistor M2 is:

Vgs=V2′−VDD=VREF−Vth−VDATA (3)

Since the second transistor M2 is operating in a saturation zone, the driving current flowing through the second transistor M2 is determined by the voltage difference between the gate and the source thereof. According to electrical property of a transistor in a saturation zone, it can be obtained that the driving current I of the second transistor M2 is:

I=K(Vsg−Vth)²=K(VREF−VDATA)² (6)

where I is the driving current generated by the second transistor M2; K is a constant; VREF is the reference voltage signal; and VDATA is the data signal. The driving current generated by the second transistor M2 is transmitted to the fourth transistor M4. Since the fourth transistor M4 is operating in a linear zone, it transmits the driving current I to the organic light emitting element OLED to drive it to light and display.

It can be appreciated that the first transistor M1, the third transistor M3, and the fourth transistor M4 can be N-type transistors, while the second transistor M2 can be a P-type transistor and parameters, such as connection relationship and signal input directions of the above-discussed first transistor M1, second transistor M2, third transistor M3, and fourth transistor M4 can be changed accordingly to alternatively achieve the functions of each of the above steps. The present invention imposes no limitation in this respect and the specific process will not be repeatedly described.

It can be seen from the above that in [symbol] the OLED pixel driving circuit 100 of the embodiment of the present invention, the data voltage signal VDATA and the reference voltage signal VREF are input to the transistor through the same wiring line and only one thin-film transistor (TFT) for driving is needed to carry out timing control output of the data voltage signal VDATA and the reference voltage signal VRE. As such, the use of circuit component (such as transistors) is reduced, the circuit structure is simplified, the wiring cost of the entire circuit is lowered down, and aperture ratio of a panel is increased through the reduction of the wiring. Further, since the magnitude of the driving current I is only related to the data voltage signal VDATA and the reference voltage signal VREF and is not related to the threshold voltage of the driving transistor M2 and the power supply voltage signal, an effect of compensation of the threshold voltage and the power supply line voltage drop can be achieved. Further, in the entire driving process, it is possible to ensure that it is always one of voltages at two terminals of the capacitor Cst is individually changing so as to reduce the influence of a parasitic capacitance coupling effect to node point potential thereby overcoming the issue of incorrect detection of threshold voltage so as to provide the OLED with accurate pixel effect to obtain bettered displaying performance.

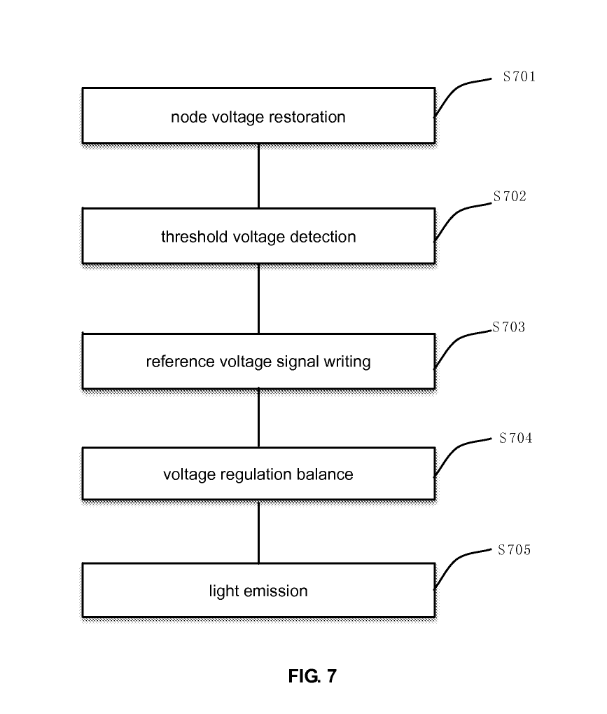

Referring to FIG. 7, FIG. 7 is a flow chart illustrating a method for driving an OLED pixel according to another embodiment of the present invention. In the instant embodiment, the first transistor M1, the second transistor M2, the third transistor M3, and the fourth transistor M4 are all P-type transistors (such as P-channel MOS-FETs). It can be appreciated that the first transistor M1, the second transistor M2, the third transistor M3, and the fourth transistor M4 can alternatively be transistors of other types (such as N-channel MOS-FETs). Repeated description will be omitted here. The instant embodiment of the present invention will be described for the first transistor M1, the second transistor M2, the third transistor M3, and the fourth transistor M4 all being P-type transistors. As shown in FIG. 7, the OLED pixel driving method comprises the following steps.

S701: node voltage restoration.

In the embodiment of the present invention, specifically, the scan driving signal applied to the gate of the first transistor M1 is a low voltage level and the first driving signal S1 is a low voltage level so that the first transistor M1, the third transistor M3, and the fourth transistor M4 conduct on; and the second driving signal S2 is a low voltage level so that the second transistor M2 is in a cut-off state. The data signal VDATA is transmitted through the first transistor M1 to the first electrode plate of the capacitor Cst (namely the first node N1 of the capacitor Cst).

S702: threshold voltage detection.

In the embodiment of the present invention, specifically, the scan driving signal applied to the gate of the first transistor M1 is a low voltage level and the first driving signal S1 is a low voltage level, so that the first transistor M1 and the third transistor M3 conduct on; and the second driving signal S2 is a high voltage level so that the second transistor M2 and the fourth transistor M4 are in a cut-off state. Since in the step of node voltage restoration, the gate of the second transistor M2 is in a low voltage level, the second transistor M2 is in a conducting-on state, so that an electric current path is established between the second transistor M2 and the third transistor M3 and a power supply voltage signal VDD is transmitted through the electric current path to the second electrode plate of the capacitor Cst (namely the second node N2 of the capacitor Cst) and thus, the potential of the second electrode plate is raised by the power supply voltage signal VDD. According to the voltage-current characteristic of a transistor, when the voltage of the gate of the second transistor M2 is pulled up to such an extent that a voltage difference thereof from the source voltage is less than or equal to the threshold voltage of the second transistor M2, the second transistor M2 is set in a cut-off state and the threshold voltage is stored in the capacitor Cst.

S703: reference voltage signal writing.

In the embodiment of the present invention, specifically, the scan driving signal applied to the gate of the first transistor M1 is a low voltage level and the first driving signal S1 is a high voltage level, so that the third transistor M3 is in a cut-off state and the first transistor M1 conducts on; and the second driving signal S2 is a high voltage level so that the second transistor M2 and the fourth transistor M4 are in a cut-off state. A reference voltage signal VREF is transmitted through the first transistor M1 to the first electrode plate of the capacitor Cst and at the same time, the second transistor M2, the third transistor M3, and the fourth transistor M4 are in a cut-off state, meaning the second electrode plate of the capacitor Cst is open so that the voltage difference Vc between the first electrode plate and the second electrode plate of the capacitor Cst is kept unchanged. The data signal VDATA is coupled, via the capacitor Cst, to the second electrode plate of the capacitor Cst.

S704: voltage regulation balance.

In the embodiment of the present invention, specifically, the scan driving signal applied to the gate of the first transistor M1 is a high voltage level and the first transistor M1 is in a cut-off state, meaning the first electrode plate of the capacitor Cst is opened; the first driving signal S1 is a high voltage level so that the third transistor M3 is in cut-off state; and the second driving signal S2 is a high voltage level, so that the second transistor M2 and the fourth transistor M4 are in a cut-off state.

S705: light emission.

In the embodiment of the present invention, specifically, the scan driving signal applied to the gate of the first transistor M1 is a high voltage level, so that the first transistor M1 is in acut-off state; the first driving signal S1 is a high voltage level, so that the third transistor M3 is in a cut-off state; and the second driving signal S2 is a low voltage level, so that the second transistor M2 and the fourth transistor M4 conduct on. Since the second transistor M2 is operating in a saturation zone, the driving current flowing through the second transistor M2 is determined by the voltage difference between the gate and the source thereof. The driving current generated by the second transistor M2 is transmitted to the fourth transistor M4. Since the fourth transistor M4 is operating in a linear zone, it transmits the driving current to an organic light emitting element OLED to drive it to light and display.

It can be appreciated that the first transistor Ml, the third transistor M3, and the fourth transistor M4 can be N-type transistors, while the second transistor M2 can be a P-type transistor and parameters, such as connection relationship and signal input directions of the above-discussed first transistor Ml, second transistor M2, third transistor M3, and fourth transistor M4 can be changed accordingly to alternatively achieve the functions of each of the above steps. The present invention imposes no limitation in this respect and the specific process will not be repeatedly described.

The present invention provides a pixel driving method of an organic light emitting display. A data voltage signal VDATA and the reference voltage signal VREF are input through the same wiring line to a transistor and only one thin-film transistor for driving is needed to carry out timing control output of the data voltage signal VDATA and the reference voltage signal VREF. As such, the use of circuit component (such as transistors) is reduced, the circuit structure is simplified, the wiring cost of the entire circuit is lowered down, and aperture ratio of a panel is increased through the reduction of the wiring.

The above illustrates only a preferred embodiment according to the present invention and is not intended to limit the scope of right of the present invention. Those having ordinary skills of the art would appreciate that various equivalent modifications that achieve all or some of the operations of the above-described embodiment and fall within scope of the attached claims are considered within the scope covered by the present invention.

What is claimed is:

1. An organic light emitting display (OLED) pixel driving circuit, comprising: a first transistor, a second transistor, a third transistor, a fourth transistor, and a capacitor;
the first transistor being controlled by a scan driving signal for controlling transmission of a data signal and a reference voltage signal a first electrode plate of the capacitor;
the second transistor being electrically connected to the second electrode plate of the capacitor for determining a magnitude of a driving current, where the driving current is determined by a voltage difference between a gate and a drain of the second transistor;
the third transistor being electrically connected to the second electrode plate of the capacitor and the second transistor and being controlled by a first driving signal for controlling conduction and cut-off between the gate and the drain of the second transistor; and
the fourth transistor being electrically connected to the second transistor and the third transistor and being controlled by a second driving signal for controlling transmission of the driving current from the second transistor to an organic light emitting element.

2. The OLED pixel driving circuit as claimed in claim 1, wherein the first transistor is a scan transistor, which has a first electrode, serving as a signal input terminal, electrically connected to a signal line and receiving inputs of the data signal and the reference voltage signal, the first transistor having a second electrode electrically connected to the first electrode plate of the capacitor, the first transistor having a gate controlled by the scan driving signal for controlling the transmission of the data signal and the reference voltage signal to the first electrode plate of the capacitor.

3. The OLED pixel driving circuit as claimed in claim 1, wherein the second transistor is a driving transistor, which has a first electrode electrically connected to a the power supply voltage signal line to receive an input of a power supply voltage signal, the second transistor having a second electrode electrically connected to a second electrode of the third transistor and a first electrode of the fourth transistor, the second transistor having a gate electrically connected to the second electrode plate of the capacitor and a first electrode of the third transistor.

4. The OLED pixel driving circuit as claimed in claim 1, wherein the third transistor is a compensation circuit transistor, which has a first electrode electrically connected to a gate of the second transistor and the second electrode plate of the capacitor, the third transistor having a second electrode electrically connected to a second electrode of the second transistor and a first electrode of the fourth transistor.

5. The OLED pixel driving circuit as claimed in claim 1, wherein the fourth transistor is node restoration control transistor, which has a first electrode electrically connected to a second electrode of the second transistor and a second electrode of the third transistor, the fourth transistor having a second electrode electrically connected to the organic light emitting element, the organic light emitting element being operable to light and display in response to the driving current.

6. The OLED pixel driving circuit as claimed in claim 1, wherein the first transistor, the second transistor, the third transistor, and the fourth transistor are all P-type transistors; or
the first transistor, the second transistor, the third transistor, and the fourth transistor are all N-type transistors; or
the first transistor, the third transistor, and the fourth transistor are N-type transistors and the second transistor is a P-type transistor.

7. The OLED pixel driving circuit as claimed in claim 1, wherein the pixel driving circuit involves a driving sequence that comprises: a node voltage restoration phase, a threshold voltage detection phase, a reference voltage signal writing phase, a voltage regulation balance phase, and a light emission phase, where in the node voltage restoration phase, the scan driving signal applied to a gate of the first transistor is a low voltage level and the first driving signal is a low voltage level so that the first transistor, the third transistor, and the fourth transistor conduct on, and the second driving signal is a low voltage level so that the second transistor is in a cut-off state.

8. The OLED pixel driving circuit as claimed in claim 7, wherein in the threshold voltage detection phase, the scan driving signal applied to the gate of the first transistor is a low voltage level and the first driving signal is a low voltage level so that the first transistor and the third transistor conduct on; the second driving signal is a high voltage level so that the second transistor and the fourth transistor is in a cut-off state; and in the threshold voltage detection phase, a voltage difference between the first electrode plate and the second electrode plate of the capacitor involve a threshold voltage of the second transistor and the threshold voltage is stored in the capacitor.

9. The OLED pixel driving circuit as claimed in claim 7, wherein in the reference voltage signal writing phase, the scan driving signal applied to the gate of the first transistor is a low voltage level and the first driving signal is a high voltage level so that the third transistor is in a cut-off state and the first transistor conducts; and the second driving signal is a high voltage level so that the second transistor and the fourth transistor are in a cut-off state; and the data signal is coupled, via the capacitor, to the second electrode plate of the capacitor.

10. The OLED pixel driving circuit as claimed in claim 7, wherein in voltage regulation balance phase, the scan driving signal applied to the gate of the first transistor is a high voltage level so that the first transistor is in a cut-off state and the first electrode plate of the capacitor is open; the first driving signal is a high voltage level so that the third transistor is in a cut-off state; and the second driving signal is a high voltage level so that the second transistor and the fourth transistor are in a cut-off state; and
in the light emission phase, the scan driving signal applied to the gate of the first transistor is a high voltage level so that the first transistor is in a cut-off state; the first driving signal is a high voltage level so that the third transistor is in a cut-off state; the second driving signal is a low voltage level so that the second transistor and the fourth transistor conduct on;
and the driving current is transmitted through the fourth transistor to the organic light emitting element to drive the organic light emitting element to light and display.

11. A driving method of an organic light emitting device (OLED), wherein the OLED driving method uses a pixel driving circuit to carry out driving of a pixel, the pixel driving circuit comprising: a first transistor, a second transistor, a third transistor, a fourth transistor, and a capacitor; the first transistor, the second transistor, the third transistor, and the fourth transistor being all P-type transistors; the driving method comprising the following steps: node voltage restoration, threshold voltage detection, reference voltage signal writing, voltage regulation balance, and light emission.

12. The driving method as claimed in claim 11, wherein in the node voltage restoration step, a scan driving signal applied to a gate of the first transistor is a low voltage level and a first driving signal is a low voltage level so that the first transistor, the third transistor, and the fourth transistor conduct on; and a second driving signal is a low voltage level so that the second transistor is in a cut-off state; a data signal being transmitted through the first transistor to a first electrode plate of a capacitor.

13. The driving method as claimed in claim 12, wherein in the threshold voltage detection step, the scan driving signal applied to the gate of the first transistor is a low voltage level and the first driving signal is a low voltage level so that the first transistor and the third transistor conduct on; the second driving signal is a high voltage level so that the second transistor and the fourth transistor are in a cut-off state; and when a gate voltage of the second transistor is pulled up to an extent that a voltage difference thereof from a source voltage is less than or equal to a threshold voltage of the second transistor, the second transistor is set in a cut-off state and the threshold voltage is stored in the capacitor.

14. The driving method as claimed in claim 12, wherein in the reference voltage signal writing step, the scan driving signal applied to the gate of the first transistor is a low voltage level and the first driving signal is a high voltage level so that the third transistor is in a cut-off state and the first transistor conducts on; the second driving signal is a high voltage level so that the second transistor and the fourth transistor are in a cut-off state; and a reference voltage signal is transmitted through the first transistor to the first electrode plate of the capacitor, the second transistor, the third transistor, and the fourth transistor being all in a cut-off state, a data signal being coupled, via the capacitor, to the second electrode plate of the capacitor.

15. The driving method as claimed in claim 12, wherein in the voltage regulation balance step, the scan driving signal applied to the gate of the first transistor is a high voltage level so that the first transistor is in a cut-off state, and the first driving signal is a high voltage level so that the third transistor is in a cut-off state; the second driving signal is a high voltage level so that the second transistor and the fourth transistor are in cut-off state; and
in the light emission phase, the scan driving signal applied to the gate of the first transistor is a high voltage level so that the first transistor is in a cut-off state; the first driving signal is a high voltage level so that the third transistor is in a cut-off state; the second driving signal is a low voltage level so that the second transistor and the fourth transistor conduct on, a driving current flowing through the fourth transistor and transmitted to the organic light emitting element to drive the organic light emitting element to light and display.

16. The driving method as claimed in claim 11, wherein the first transistor is a scan transistor; the second transistor is a driving transistor; the third transistor is a compensation circuit transistor; the fourth transistor is a node restoration control transistor; and the capacitor is a storage capacitor.

17. An organic light emitting display (OLED), comprising an organic light emitting element, wherein the OLED further comprises a pixel driving circuit, the OLED pixel driving circuit comprising: a first transistor, a second transistor, a third transistor, a fourth transistor, and a capacitor; the first transistor being controlled by a scan driving signal for controlling transmission of a data signal and a reference voltage signal a first electrode plate of the capacitor; the second transistor being electrically connected to the second electrode plate of the capacitor for determining a magnitude of a driving current, where the driving current is determined by a voltage difference between a gate and a drain of the second transistor; the third transistor being electrically connected to the second electrode plate of the capacitor and the second transistor and being controlled by a first driving signal for controlling conduction and cut-off between the gate and the drain of the second transistor; and the fourth transistor being electrically connected to the second transistor and the third transistor and being controlled by a second driving signal for controlling transmission of the driving current from the second transistor to an organic light emitting element, the organic light emitting element being operable to emit light in response to the driving current.
